(19) United States
(12) Patent Application Publication
(10) Pub. No.: US 2025/0219477 A1
(43) Pub. Date: Jul. 3, 2025

(54) MAGNETIC CORE, COIL-EQUIPPED MAGNETIC CORE, AND ROTARY ELECTRIC MACHINE

(71) Applicant: Murata Manufacturing Co., Ltd., Nagaokakyo-shi (JP)

(72) Inventors: Takashi SAKURADA, Nagaokakyo-shi (JP); Hisato AMANO, Nagaokakyo-shi (JP)

(21) Appl. No.: 19/081,227

(22) Filed: Mar. 17, 2025

Related U.S. Application Data
(63) Continuation of application No. PCT/JP2023/046594, filed on Dec. 26, 2023.

(30) Foreign Application Priority Data
Dec. 28, 2022 (JP) 2022-211283

(51) Int. Cl. H02K 1/14

(52) U.S. Cl. CPC H02K 1/146

(57) ABSTRACT

A magnetic core that includes: a core back part; and a teeth part, wherein the core back part has: a first end surface directed in an axial direction and extending along a rotary axis of a rotary electric machine, and a second end surface directed in a direction opposite from the axial direction, and a first side surface and a second side surface positioned side by side in a circumferential direction about the rotary axis, and the core back part has a shape where a notch surface is interposed in between at least one of: (1) the first end surface and the first side surface, (2) the first end surface and the second side surface, (3) the second end surface and the first side surface, and (4) the second end surface and the second side surface.

### CROSS REFERENCE TO RELATED APPLICATIONS

The present application is a continuation of International application No. PCT/JP2023/046594, filed Dec. 26, 2023, which claims priority to Japanese Patent Application No. 2022-211283, filed Dec. 28, 2022, the entire contents of each of which are incorporated herein by reference.

### TECHNICAL FIELD

The present disclosure relates to a magnetic core used in a rotary electric machine, a coil-equipped magnetic core, and the rotary electric machine.

### BACKGROUND ART

A stator core described in PTL 1 is known as an example of an invention pertaining to a magnetic core in the prior art. The stator core described in PTL 1 includes a yoke part and a tooth. A coil is wound on the tooth. The yoke part has two end faces: one of them facing in an axial direction extending along the rotary axis of a rotary electric machine and the other one facing in a direction opposite from the axial direction, with the stator core mounted in the rotary electric machine.
PTL 1: Japanese Unexamined Patent Application Publication No. 2006-158176

### SUMMARY OF THE DISCLOSURE

There are demands that a region for allowing both end portions of a coil to be led out be secured in the stator core described in PTL 1.

Thus, the present disclosure aims to provide a magnetic core, a coil-equipped magnetic core, and a rotary electric machine which have a region secured for allowing both end portions of a coil to be led out.

A magnetic core according to an aspect of the present disclosure includes: a core back part; and a teeth part, wherein the core back part has: a first end surface directed in an axial direction and extending along a rotary axis of the rotary electric machine, and a second end surface directed in a direction opposite from the axial direction when the magnetic core is mounted in the rotary electric machine, and a first side surface and a second side surface positioned side by side in a circumferential direction about the rotary axis when the magnetic core is mounted in the rotary electric machine, and the core back part has a shape where a notch surface is interposed in between at least one of: (1) the first end surface and the first side surface, (2) the first end surface and the second side surface, (3) the second end surface and the first side surface, and (4) the second end surface and the second side surface.

A magnetic core according to another aspect of the present disclosure includes: a core back part; and a teeth part, wherein the teeth part includes: a teeth main body portion extending from the core back part toward a rotor of the rotary electric machine when the magnetic core is mounted in the rotary electric machine and a teeth tip end portion at a tip end of the teeth main body portion, wherein the teeth tip end portion has: a first end surface directed in an axial direction and extending along a rotary axis of the rotary electric machine, and a second end surface directed in a direction opposite from the axial direction when the magnetic core is mounted in the rotary electric machine, and a first side surface and a second side surface positioned side by side in a circumferential direction about the rotary axis when the magnetic core is mounted in the rotary electric machine, and the teeth tip end portion has a shape where a notch surface interposed in between at least one of: (1) the first end surface and the first side surface, (2) the first end surface and the second side surface, (3) the second end surface and the first side surface, and (4) the second end surface and the second side surface.

The present disclosure can provide a magnetic core, a coil-equipped magnetic core, and a rotary electric machine which have a region secured for allowing both end portions of a coil to be led out.

### BRIEF DESCRIPTION OF THE DRAWINGS

FIG. 1 is a perspective view of a magnetic core 1 according to a first embodiment of the present disclosure.

FIG. 2 is a sectional view of a core back part 2 as seen from a first direction DIR1.

FIG. 3 is a perspective view of a coil-equipped magnetic core 14.

FIG. 4 is sectional view of the core back part 2 and a coil 13 as seen from the first direction DIR1.

FIG. 5 is a perspective view of the outer appearance of a brushless motor 100 in which the magnetic core 1 is used.

FIG. 6 is a rough exploded perspective view of the brushless motor 100 in which the magnetic core 1 is used.

FIG. 7 is a perspective view of a magnetic core 1a according to a first modification of the present disclosure.

FIG. 8 is sectional view of the core back part 2 and the coil 13 as seen from the first direction DIR1.

FIG. 9 is a perspective view of a magnetic core 1b according to a second modification of the present disclosure.

FIG. 10 is a sectional view of the core back part 2 and the coil 13 as seen from the first direction DIR1.

FIG. 11 is a perspective view of a magnetic core 1c according to a third modification of the present disclosure.

FIG. 12 is a sectional view of the core back part 2 as seen from the first direction DIR1.

FIG. 13 is a perspective view of a magnetic core 1d according to a fourth modification of the present disclosure.

FIG. 14 is a sectional view of the core back part 2 as seen from the first direction DIR1.

FIG. 15 is a perspective view of a magnetic core 1e according to a fifth modification of the present disclosure.

FIG. 16 is a sectional view of the core back part 2 as seen from the first direction DIR1.

FIG. 17 is a perspective view of a magnetic core 1f according to a second embodiment of the present disclosure.

FIG. 18 is a sectional view of a teeth tip end portion 32 as seen in the first direction DIR1.

FIG. 19 is a perspective view of a coil-equipped magnetic core 14f.

FIG. 20 is a sectional view of the teeth tip end portion 32 and the coil 13 as seen in the first direction DIR1.

FIG. 21 is a perspective view of a magnetic core 1g according to a sixth modification of the present disclosure.

FIG. 22 is a sectional view of the teeth tip end portion 32 and the coil 13 as seen in the first direction DIR1.

FIG. 23 is a perspective view of a magnetic core 1h according to a seventh modification of the present disclosure.

FIG. 24 is a sectional view of the teeth tip end portion 32 and the coil 13 as seen in the first direction DIR1.

FIG. 25 is a perspective view of a magnetic core 1i according to an eighth modification of the present disclosure.

FIG. 26 is a sectional view of the teeth tip end portion 32 as seen in the first direction DIR1.

FIG. 27 is a perspective view of a magnetic core 1j according to a ninth modification of the present disclosure.

FIG. 28 is a sectional view of the teeth tip end portion 32 as seen in the first direction DIR1.

FIG. 29 is a perspective view of a magnetic core 1k according to a tenth modification of the present disclosure.

FIG. 30 is a sectional view of the teeth tip end portion 32 as seen in the first direction DIR1.

### DESCRIPTION OF THE PREFERRED EMBODIMENTS

### First Embodiment

### Configuration of a Magnetic Core 1

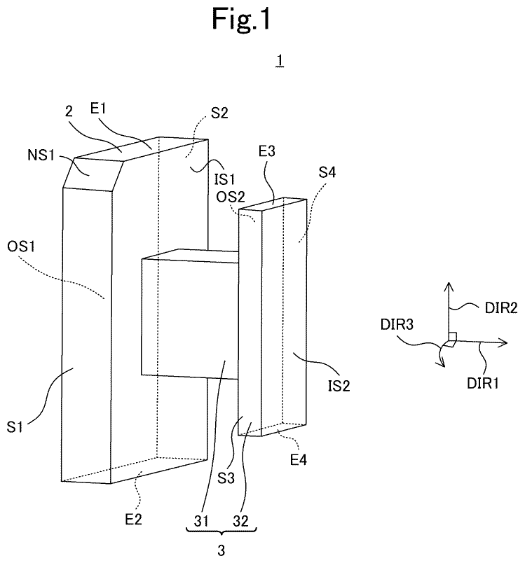

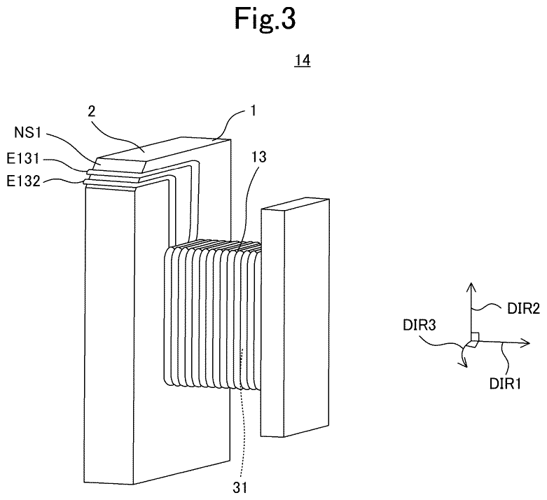

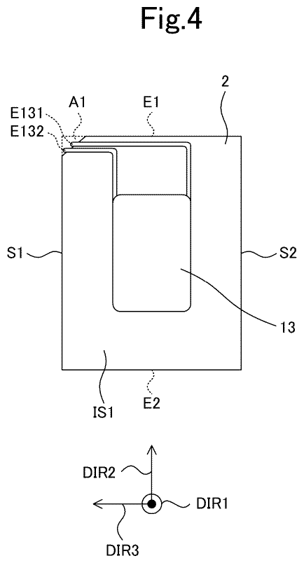

FIG. 1 is a perspective view of a magnetic core 1 according to a first embodiment of the present disclosure. As shown in FIG. 1, the magnetic core 1 has a core back part 2 and a teeth part 3. The teeth part 3 is shaped in such a manner as to extend from the core back part 2 in a first direction DIR1. The teeth part 3 includes a teeth main body portion 31 extending from the core back part 2 in the first direction DIR1 and a teeth tip end portion 32 formed at a tip end of the teeth main body portion 31 in terms of the first direction DIR1. A coil 13 is wound on the teeth part 3. More specifically, as will be described later, the coil 13 is wound on the teeth main body portion 31. The magnetic core 1 of the present embodiment is used in a brushless motor 100 to be described later (an example of the “rotary electric machine” of the present disclosure; see FIGS. 3 and 4). When the magnetic core 1 is mounted in the brushless motor 100, the first direction DIR1 is directed in a direction opposite from a radial direction about the rotary axis of the brushless motor 100. Also, when the magnetic core 1 is mounted in the brushless motor 100, a second direction DIR2 is directed in an axial direction extending along the rotary axis of the brushless motor 100. Note that when the magnetic core 1 is mounted in the brushless motor 100, a direction opposite from the second direction DIR2 is also directed in the axial direction extending along the rotary axis of the brushless motor 100. Further, when the magnetic core 1 is mounted in the brushless motor 100, a third direction DIR3 is directed in a circumferential direction about the rotary axis of the brushless motor 100. Note that when the magnetic core 1 is mounted in the brushless motor 100, a direction opposite from the third direction DIR3 is also directed in the circumferential direction about the rotary axis of the brushless motor 100. Detailed descriptions are given below.

The magnetic core 1 is a soft magnetic body. A soft magnetic body is magnetized when a magnetic field is applied thereto from outside. After that, when the application of the magnetic field stops, the soft magnetic body loses its magnetic property. An example material for such a soft magnetic body is iron.

The magnetic core 1 is a compact formed from soft magnetic powder. Specifically, the core back part 2 and the teeth part 3 are each a compact formed from soft magnetic powder. Example materials for the soft magnetic powder include iron and a binder. An example of the binder is resin. The soft magnetic powder is, for example, a mixture of iron powder and epoxy resin as an example of the binder. Such a magnetic core 1 is fabricated by, for example, press forming. Also, an insulating treatment is performed on the outer surface of the magnetic core 1 which comes into contact a different member when the magnetic core 1 is mounted in the brushless motor 100.

As shown in FIG. 1, the core back part 2 has a first end surface E1, a second end surface E2, a first side surface S1, a second side surface S2, a first inner main surface IS1, and a first outer main surface OS1. The first end surface E1 is an end surface of the core back part 2 in terms of the second direction DIR2. The second end surface E2 is an end surface of the core back part 2 in terms of a direction opposite from the second direction DIR2. In the present embodiment, the first end surface E1 and the second end surface E2 are each a flat surface. The first end surface E1 is located farther in the second direction DIR2 than the second end surface E2. When the magnetic core 1 is mounted in the brushless motor 100, the first end surface E1 is directed in the second direction DIR2. Also, when the magnetic core 1 is mounted in the brushless motor 100, the second end surface E2 is directed in a direction opposite from the second direction DIR2. In other words, the core back part 2 has two end surfaces: the first end surface E1 facing in the axial direction extending along the rotary axis of the brushless motor 100 and the second end surface E2 facing in a direction opposite from the axial direction, when the magnetic core 1 is mounted in the brushless motor 100.

As shown in FIG. 1, the first side surface S1 and the second side surface S2 are each a surface joining the respective end edges of the first end surface E1 and the second end surface E2 in terms of the third direction DIR3 to each other. The first side surface S1 is an end surface of the core back part 2 in terms of the third direction DIR3. The second side surface S2 is an end surface of the core back part 2 in terms of a direction opposite from the third direction DIR3. Thus, when the magnetic core 1 is mounted in the brushless motor 100, the first side surface S1 and the second side surface S2 are located side by side in the third direction DIR3. Thus, the core back part 2 has two side surfaces, the first side surface S1 and the second side surface S2, located side by side in the circumferential direction about the rotary axis of the brushless motor 100 when the magnetic core 1 is mounted in the brushless motor 100. In the present embodiment, the first side surface S1 and the second side surface S2 are each a flat surface.

As shown in FIG. 1, the first inner main surface IS1 and the first outer main surface OS1 are each a surface joining the respective end edges of the first end surface E1 and the second end surface E2 in terms of the first direction DIR1 to each other. The first inner main surface IS1 is an end surface of the core back part 2 in terms of the first direction DIR1. The first outer main surface OS1 is an end surface of the core back part 2 in terms of a direction opposite from the first direction DIR1. Thus, when the magnetic core 1 is mounted in the brushless motor 100, the first outer main surface OS1 and the first inner main surface IS1 are located side by side in the first direction DIR1. In other words, the core back part 2 has two main surfaces, the first inner main surface IS1 and the first outer main surface OS1, located side by side in the radial direction of the rotary axis of the brushless motor 100, when the magnetic core 1 is mounted in the brushless motor 100. In the present embodiment, the first inner main surface IS1 and the first outer main surface OS1 are each a flat surface.

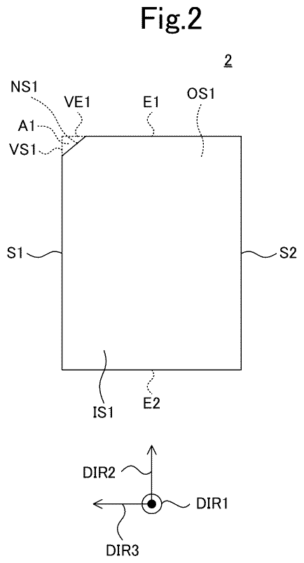

FIG. 2 is a sectional view of the core back part 2 as seen from the first direction DIR1. The core back part 2 has a shape such that, regarding four combinations of surfaces one of which is selected from the two end surfaces, namely the first end surface E1 and the second end surface E2, and the other one of which is selected from the two side surfaces, namely the first side surface S1 and the second side surface S2, the end surface and the side surface are joined with a notch surface interposed therebetween at least one of such four combinations. Specifically, conceivable four combinations are as follows: a combination of the first end surface E1 and the first side surface S1, a combination of the first end surface E1 and the second side surface S2, a combination of the second end surface E2 and the first side surface S1, and a combination of the second end surface E2 and the second side surface S2. In the present embodiment, as shown in FIGS. 1 and 2, the core back part 2 has a shape such that the first end surface E1 and the first side surface S1 are joined with a first notch surface NS1 interposed therebetween. Also, in the present embodiment, the first inner main surface IS1 and the first outer main surface OS1 are joined with the first notch surface NS1 interposed therebetween.

As shown in FIG. 2, the first notch surface NS1 is, focusing on the combination of the first end surface E1 and the first side surface S1 joined by the first notch surface NS1, a surface formed to notch a portion of intersection between a first virtual extended end surface VE1 extended from the first end surface E1 in the third direction DIR3 and a first virtual extended side surface VS1 extended from the first side surface S1 in the second direction DIR2. Note that the first virtual extended end surface VE1 is a surface extended from the first end surface E1 in the circumferential direction about the rotary axis of the brushless motor 100 when the magnetic core 1 is mounted in the brushless motor 100. Also, the first virtual extended side surface VS1 is a surface extended from the first side surface S1 in the axial direction extending along the rotary axis of the brushless motor 100 when the magnetic core 1 is mounted in the brushless motor 100. In the present embodiment, as shown in FIGS. 1 and 2, the first notch surface NS1 is a flat surface. As shown in FIG. 2, a region surrounded by the first virtual extended end surface VE1, the first virtual extended side surface VS1, and the first notch surface NS1 is defined as a first region A1.

As shown in FIG. 1, the teeth main body portion 31 extends from the first inner main surface IS1 of the core back part 2 in the first direction DIR1. When the magnetic core 1 is mounted in the brushless motor 100, the teeth main body portion 31 extends from the core back part 2 toward the rotor of the brushless motor 100. In the present embodiment, the teeth main body portion 31 is cuboid.

As shown in FIG. 1, the teeth tip end portion 32 has a third end surface E3, a fourth end surface E4, a third side surface S3, a fourth side surface S4, a second inner main surface IS2, and a second outer main surface OS2. The third end surface E3 is an end surface of the teeth tip end portion 32 in terms of the second direction DIR2. The fourth end surface E4 is an end surface of the teeth tip end portion 32 in terms of a direction opposite from the second direction DIR2. In the present embodiment, the third end surface E3 and the fourth end surface E4 are each a flat surface. The third end surface E3 is located farther in the second direction DIR2 than the fourth end surface E4. When the magnetic core 1 is mounted in the brushless motor 100, the third end surface E3 is directed in the second direction DIR2. Also, when the magnetic core 1 is mounted in the brushless motor 100, the fourth end surface E4 is directed in a direction opposite from the second direction DIR2. In other words, the teeth tip end portion 32 has two end surfaces: the third end surface E3 facing in the axial direction extending along the rotary axis of the brushless motor 100 and the fourth end surface E4 facing in a direction opposite from the axial direction, when the magnetic core 1 is mounted in the brushless motor 100.

As shown in FIG. 1, the third side surface S3 and the fourth side surface S4 are each a surface joining the respective end edges of the third end surface E3 and the fourth end surface E4 in terms of the third direction DIR3 to each other. The third side surface S3 is an end surface of the teeth tip end portion 32 in terms of the third direction DIR3. The fourth side surface S4 is an end surface of the teeth tip end portion 32 in terms of a direction opposite from the third direction DIR3. Thus, when the magnetic core 1 is mounted in the brushless motor 100, the third side surface S3 and the fourth side surface S4 are located side by side in the third direction DIR3. Thus, the teeth tip end portion 32 has two side surfaces, the third side surface S3 and the fourth side surface S4, located side by side in the circumferential direction about the rotary axis of the brushless motor 100, when the magnetic core 1 is mounted in the brushless motor 100. In the present embodiment, the third side surface S3 and the fourth side surface S4 are each a flat surface.

As shown in FIG. 1, the second inner main surface IS2 and the second outer main surface OS2 are each a surface joining the respective end edges of the third end surface E3 and end edges of the fourth end surface E4 in terms of the first direction DIR to each other. The second inner main surface IS2 is an end surface of the teeth tip end portion 32 in terms of the first direction DIR1. The second outer main surface OS2 is an end surface of the teeth tip end portion 32 in terms of a direction opposite from the first direction DIR1. Thus, when the magnetic core 1 is mounted in the brushless motor 100, the second outer main surface OS2 and the second inner main surface IS2 are located side by side in the first direction DIR1. In other words, the teeth tip end portion 32 has two main surfaces: the second inner main surface IS2 and the second outer main surface OS2 located side by side in the radial direction of the rotary axis of the brushless motor 100 when the magnetic core 1 is mounted in the brushless motor 100. In the present embodiment, the second inner main surface IS2 and the second outer main surface OS2 are each a flat surface.

### Configuration of a Coil-Equipped Magnetic Core 14

The configuration of a coil-equipped magnetic core 14 according to the first embodiment of the present disclosure is described below with reference to the drawings. FIG. 3 is a perspective view of the coil-equipped magnetic core 14. FIG. 4 is a sectional view of the core back part 2 and the coil 13 as seen from the first direction DIR1.

As shown in FIG. 3, the coil-equipped magnetic core 14 has the magnetic core 1 and the coil 13.

As shown in FIG. 3, the coil 13 is wound on the teeth main body portion 31. The coil 13 is fabricated from, for example, a conductive material such as copper. Also, the coil 13 has a structure such that the surface of a copper wire is covered by an insulation coating. Having the structure where the surface of a copper wire is covered by an insulation coating, the coil 13 is electrically insulated from the magnetic core 1. The coil 13 generates a magnetic field when a current is passed through the coil 13 with the coil 13 mounted in the brushless motor 100.

As shown in FIG. 3, the coil 13 has a first end E131 and a second end E132. The first end E131 and the second end E132 are the respective end portions of the coil 13. When the magnetic core 1 is mounted in the brushless motor 100, the first end E131 and the second end E132 of the coil 13 are each supplied with an electric signal from a power source (not shown). In this regard, for example, the first end E131 and the second end E132 are each fixed to a terminal block (not shown) located farther in a direction opposite from the first direction DIR1 than the core back part 2. As shown in FIGS. 3 and 4, the coil 13 passes through the first region A1.

### Configuration of the Brushless Motor 100

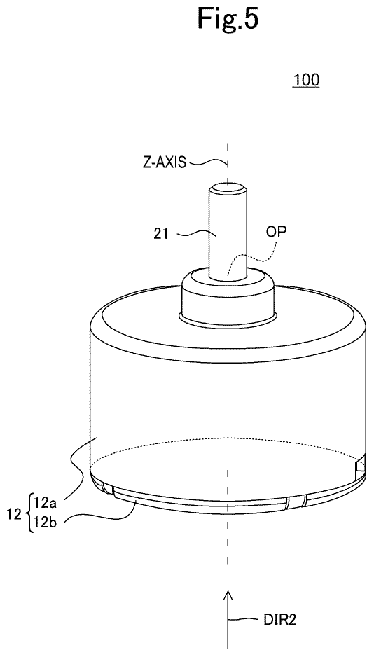

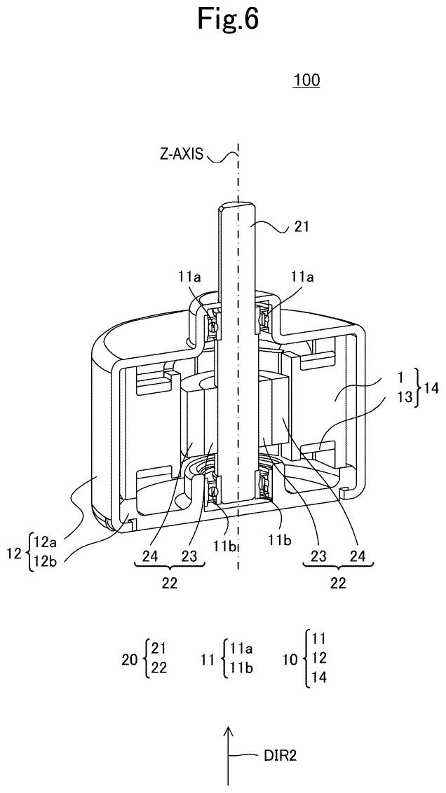

The configuration of the brushless motor 100 according to the first embodiment of the present disclosure is described below with reference to the drawings. FIG. 5 is a perspective view of the outer appearance of the brushless motor 100 in which the magnetic core 1 is used. FIG. 6 is a rough exploded perspective view of the brushless motor 100 in which the magnetic core 1 is used. Note that in FIG. 6, reference numerals are given only to a representative set of the magnetic core 1, the coil 13, and the coil-equipped magnetic core 14 among the plurality of magnetic cores 1, the plurality of coils 13, and the plurality of coil-equipped magnetic cores 14.

As shown in FIGS. 5 and 6, the brushless motor 100 has a rotor 20 and a stator assembly 10. As shown in FIG. 6, the stator assembly 10 is disposed surrounding the rotor 20 when seen in the second direction DIR2. Thus, the brushless motor 100 is an inner rotor type.

As shown in FIG. 6, the rotor 20 has a shaft 21 and a rotor member 22. The shaft 21 is shaped in such a manner as to extend in the second direction DIR2. More specifically, the shaft 21 is columnar. The rotor member 22 is tubular. The center axes of the shaft 21 and the rotor member 22 are a Z-axis. In other words, the rotary axis of the brushless motor 100 is the Z-axis. Thus, the second direction DIR2 is a direction along the Z-axis.

As shown in FIG. 6, the rotor member 22 includes a soft magnetic body 23 and a hard magnetic body 24. The rotor member 22 is attached to the outer circumferential surface of the shaft 21 in terms of the radial direction about the Z-axis. More specifically, the soft magnetic body 23 is attached to the outer circumferential surface of the shaft 21 in terms of the radial direction about the Z-axis. The hard magnetic body 24 is attached to the outer circumferential surface of the soft magnetic body 23 in terms of the radial direction about the Z-axis.

The soft magnetic body 23 is a soft magnetic body, and the hard magnetic body 24 is a hard magnetic body. The hard magnetic body is magnetized when a magnetic field is applied thereto from outside. After that, even after the application of a magnetic field is stopped, the hard magnetic body stays magnetized. An example material for such a hard magnetic body is a magnet.

As shown in FIG. 6, the stator assembly 10 includes a bearing 11, a casing 12, and a plurality of coil-equipped magnetic cores 14. Each of the plurality of coil-equipped magnetic cores 14 has the magnetic core 1 and the coil 13. In other words, the brushless motor 100 has the magnetic cores 1.

The bearing 11 supports the shaft 21 while allowing the shaft 21 to rotate in the circumferential direction about the Z-axis. More specifically, as shown in FIG. 6, the bearing 11 has a first bearing 11a and a second bearing 11b. For example, the first bearing 11a and the second bearing 11b are each a ball bearing. The first bearing 11a and the second bearing 11b are each tubular. The center axes of the first bearing 11a and the second bearing 11b are the Z-axis. Thus, the center axes of the first bearing 11a and the second bearing 11b coincide with the center axis of the shaft 21.

As shown in FIG. 6, the second bearing 11b is located farther in a direction opposite from the second direction DIR2 than the first bearing 11a. Also, the first bearing 11a is located farther in the second direction DIR2 than the rotor member 22. The second bearing 11b is located farther in a direction opposite from the second direction DIR2 than the rotor member 22. The second bearing 11b supports an end of the shaft 21 in terms of the second direction DIR2.

As shown in FIG. 5, the casing 12 has a first casing 12a and a second casing 12b. As shown in FIGS. 5 and 6, the first casing 12a is tubular. The center axis of the first casing 12a is the Z-axis. The first casing 12a is located farther in the second direction DIR2 than the second casing 12b. Also, the first casing 12a has an opening OP. Through the opening OP, an end of the shaft 21 in terms of the second direction DIR2 protrudes in the second direction DIR2. In other words, the brushless motor 100 is a single-shaft type.

The first casing 12a supports the first bearing 11a, the plurality of magnetic cores 1, and the plurality of coils 13. The second casing 12b supports the second bearing 11b. A material for each of the first casing 12a and the second casing 12b is, for example, a material with high rigidity such as SUS.

There are nine coil-equipped magnetic cores 14. The nine coil-equipped magnetic cores 14 are arranged side by side in the circumferential direction about the Z-axis. The nine coil-equipped magnetic cores 14 are disposed surrounding the hard magnetic body 24 with a gap from the hard magnetic body 24.

The magnetic core 1 is magnetized by a magnetic field generated by the hard magnetic body 24 and a magnetic field generated by the coil 13 to be described later. Note that there is an air gap between the magnetic core 1 and the rotor member 22, as shown in FIG. 6.

The coil 13 is supplied with a current from the power source (not shown). The rotation of the rotor 20 is controlled by control of this current.

### Advantageous Effects

According to the magnetic core 1, a region is secured for allowing both end portions of the coil to be led out. More specifically, the core back part 2 has a shape such that the first end surface E1 and the first side surface S1 are joined with the first notch surface NS1 interposed therebetween. Thus, the core back part 2 has a shape such that the first end surface E1 and the first side surface S1 are notched by the first notch surface NS1. This allows both end portions of the coil 13 wound on the teeth part 3 to be led out through the region created by the notching of the first notch surface NS1. As a result, according to the magnetic core 1, a region can be secured for leading out both end portions of the coil.

Also, according to the magnetic core 1, both end portions of the coil can be led out without a size increase of the rotary electric machine. More specifically, the first notch surface NS1 is, focusing on the combination of the first end surface E1 and the first side surface S1 joined by the first notch surface NS1, a surface formed to notch a portion of intersection between the first virtual extended end surface VE1 extended from the first end surface E1 in the third direction DIR3 and the first virtual extended side surface VS1 extended from the first side surface S1 in the second direction DIR2. This enables both end portions of the coil 13 to be led out through the first region A1, which is a region surrounded by the first virtual extended end surface VE1, the first virtual extended side surface VS1, and the first notch surface NS1. Thus, according to the magnetic core 1, there is no need to secure a region for allowing both ends of coil to be led out, outside of the magnetic core 1. As a result, according to the magnetic core 1, both end portions of the coil can be led out without a size increase of the rotary electric machine.

Also, according to the magnetic core 1, a notch surface can be formed easily. More specifically, for example, in a case where a magnetic core is fabricated by lamination of electromagnetic steel sheets, after the electromagnetic steel sheets are laminated, a cutting process is needed to form the first notch surface NS1. By contrast, the magnetic core 1 is a compact formed from soft magnetic powder. Thus, fabrication of the magnetic core 1 does not require a cutting process for forming the first notch surface NS1. As a result, according to the magnetic core 1, a notch surface can be formed easily.

Alternatively, in a case where the magnetic core is fabricated by lamination of electromagnetic steel sheets, the notch surface can be formed by pre-adjustment of the widths of the electromagnetic steel sheets. In this case, the notch surface has a step. In this case, there is a concern that the insulation coating of the coil 13 may be damaged as a result of the coil 13 coming into contact with the corner of the step of the notch surface. By contrast, the magnetic core 1 is a compact formed from soft magnetic powder. Thus, in the fabrication of the magnetic core 1, a notch surface without a step can be formed, which eliminates the concern of the notch surface damaging the insulation coating of the coil 13.

### First Modification

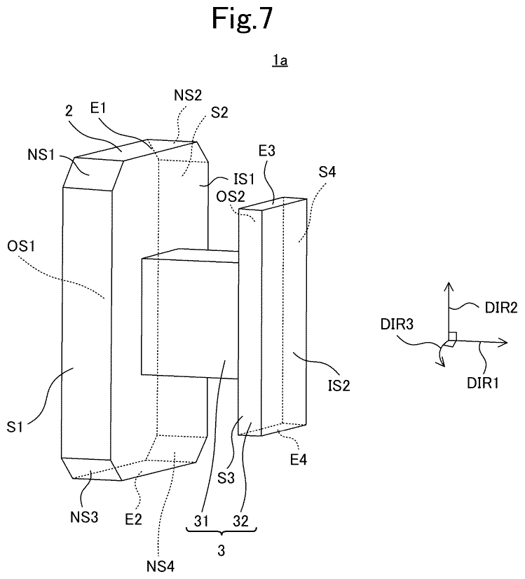

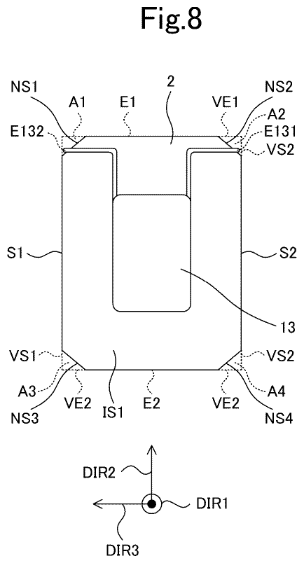

A magnetic core 1a and a coil-equipped magnetic core 14a according to a first modification of the present disclosure are described below with reference to the drawings. FIG. 7 is a perspective view of the magnetic core 1a according to the first modification of the present disclosure. FIG. 8 is a sectional view of the core back part 2 and the coil 13 as seen from the first direction DIR1. Note that the following describes only differences of the magnetic core 1a and the coil-equipped magnetic core 14a according to the first modification from the magnetic core 1 and the coil-equipped magnetic core 14 according to the first embodiment and omits the rest.

As shown in FIGS. 7 and 8, the magnetic core 1a and the coil-equipped magnetic core 14a differ from the magnetic core 1 and the coil-equipped magnetic core 14 in the shape of the core back part 2 such that the end surface and the side surface are joined by a notch surface at all of the four combinations of surfaces one of which is selected from the first end surface E1 and the second end surface E2 and the other one of which is selected from the first side surface S1 and the second side surface S2.

In the present modification, as shown in FIGS. 7 and 8, the first end surface E1 and the second side surface S2 are joined by a second notch surface NS2. Also, the second end surface E2 and the first side surface S1 are joined by a third notch surface NS3. Also, the second end surface E2 and the second side surface S2 are joined by a fourth notch surface NS4. Also, in the present modification, the first inner main surface IS1 and the first outer main surface OS1 are joined by the first notch surface NS1, the second notch surface NS2, the third notch surface NS3, and the fourth notch surface NS4.

As shown in FIG. 8, the second notch surface NS2 is, focusing on the combination of the first end surface E1 and the second side surface S2 joined by the second notch surface NS2, a surface formed to notch a portion of intersection between the first virtual extended end surface VE1 extended from the first end surface E1 in a direction opposite from the third direction DIR3 and a second virtual extended side surface VS2 extended from the second side surface S2 in the second direction DIR2. In the present modification, as shown in FIGS. 7 and 8, the second notch surface NS2 is a flat surface. As shown in FIG. 8, a region surrounded by the first virtual extended end surface VE1, the second virtual extended side surface VS2, and the second notch surface NS2 is defined as a second region A2.

As shown in FIG. 8, the third notch surface NS3 is, focusing on the combination of the second end surface E2 and the first side surface S1 joined by the third notch surface NS3, a surface formed to notch a portion of intersection between a second virtual extended end surface VE2 extended from the second end surface E2 in the third direction DIR3, and the first virtual extended side surface VS1 extended from the first side surface S1 in a direction opposite from the second direction DIR2. In the present modification, as shown in FIGS. 7 and 8, the third notch surface NS3 is a flat surface. As shown in FIG. 8, a region surrounded by the second virtual extended end surface VE2, the first virtual extended side surface VS1, and the third notch surface NS3 is defined as a third region A3.

As shown in FIG. 8, the fourth notch surface NS4 is, focusing on the combination of the second end surface E2 and the second side surface S2 joined by the fourth notch surface NS4, a surface formed to notch a portion of intersection between the second virtual extended end surface VE2 extended from the second end surface E2 in a direction opposite from the third direction DIR3 and the second virtual extended side surface VS2 extended from the second side surface S2 in a direction opposite from the second direction DIR2. In the present modification, as shown in FIGS. 7 and 8, the fourth notch surface NS4 is a flat surface. As shown in FIG. 8, a region surrounded by the second virtual extended end surface VE2, the second virtual extended side surface VS2, and the fourth notch surface NS4 is defined as a fourth region A4.

In the present modification, as shown in FIG. 8, the coil 13 passes through each of the first region A1 and the second region A2.

The magnetic core 1a above offers the same advantageous effects as the magnetic core 1. In addition, according to the magnetic core 1a, chipping of the core back part can be reduced. More specifically, the end surface and the side surface are joined by a notch surface at all of the four combinations of surfaces one of which is selected from the first end surface E1 and the second end surface E2 and the other one of which is selected from the first side surface S1 and the second side surface S2. Thus, according to the magnetic core 1a, chipping of the core back part can be reduced.

Also, according to the magnetic core 1a, the degree of freedom for the coil wiring layout is improved. More specifically, the end surface and the side surface are joined by a notch surface at a plurality of ones of the four combinations of surfaces one of which is selected from the first end surface E1 and the second end surface E2 and the other one of which is selected from the first side surface S1 and the second side surface S2. Thus, both end portions of the coil 13 can be led out through at least one of the first region A1, the second region A2, the third region A3, and the fourth region A4. As a result, according to the magnetic core 1a, the degree of freedom for the coil wiring layout is improved.

### Second Modification

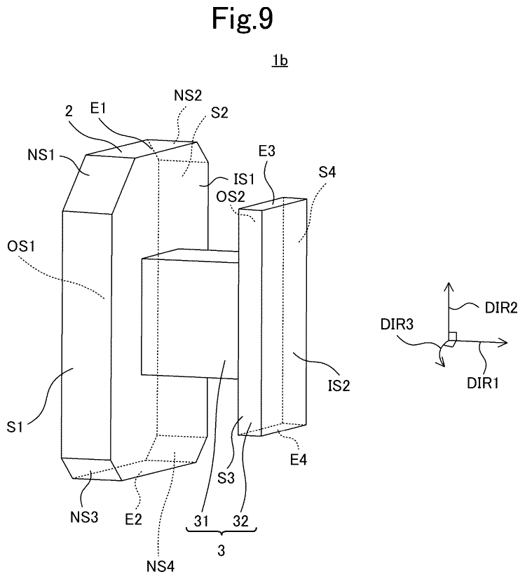

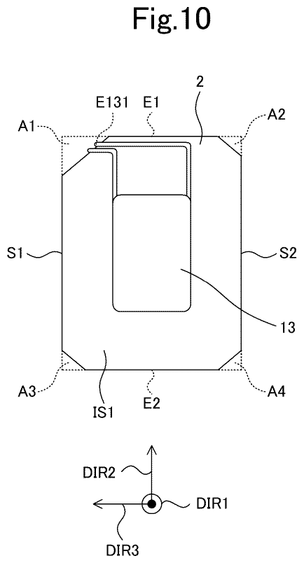

A magnetic core 1b and a coil-equipped magnetic core 14b according to a second modification of the present disclosure are described below with reference to the drawings. FIG. 9 is a perspective view of the magnetic core 1b according to the second modification of the present disclosure. FIG. 10 is a sectional view of the core back part 2 and the coil 13 as seen from the first direction DIR1. Note that the following describes only differences of the magnetic core 1b and the coil-equipped magnetic core 14b according to the second modification from the magnetic core 1a and the coil-equipped magnetic core 14a according to the first modification and omits the rest.

As shown in FIGS. 9 and 10, the magnetic core 1b and the coil-equipped magnetic core 14b differ from the magnetic core 1a and the coil-equipped magnetic core 14a in that the area of the first region A1 is larger than each of the area of the second region A2, the area of the third region A3, and the area of the fourth region A4.

In the present modification, as shown in FIG. 10, the coil 13 passes through the first region A1. Meanwhile, the coil 13 passes through neither of the second region A2, the third region A3, and the fourth region A4. In other words, the coil 13 passes through the first region A1, which is a region with the largest area among the first region A1, the second region A2, the third region A3, and the fourth region A4.

The magnetic core 1b above offers the same advantageous effects as the magnetic core 1a. Also, according to the magnetic core 1b, chipping of the core back part is reduced with a region secured for allowing both end portions of the coil to be led out. More specifically, the area of the first region A1 is larger than each of the area of the second region A2, the area of the third region A3, and the area of the fourth region A4. Thus, the coil 13 can pass through the first region A1, which is a region with the largest area. Also, the end surface and the side surface are joined by a notch surface at a plurality of ones of the four combinations of surfaces one of which is selected from the first end surface E1 and the second end surface E2 and the other one of which is selected from the first side surface S1 and the second side surface S2. Thus, chipping of the core back part 2 can be reduced. As a result, according to the magnetic core 1b, chipping of the core back part can be reduced with a region secured for allowing both end portions of the coil to be led out.

### Third Modification

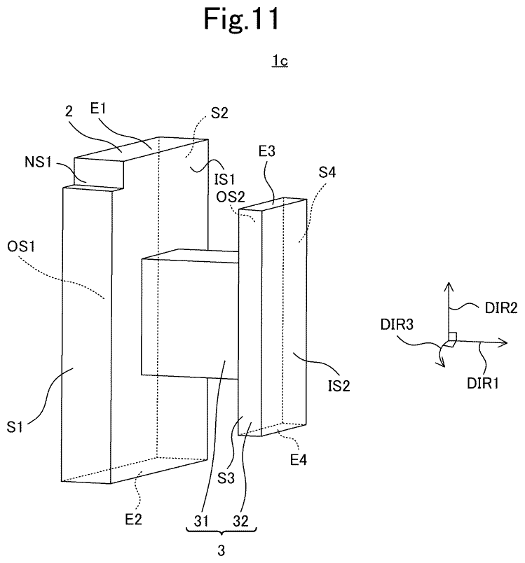

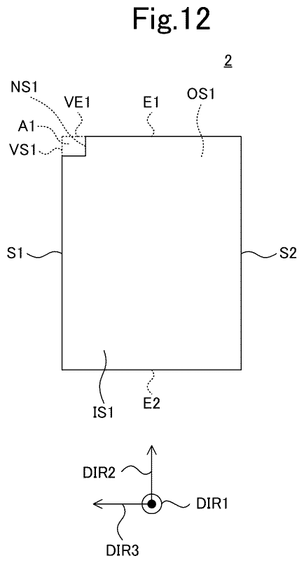

A magnetic core 1c according to a third modification of the present disclosure is described below with reference to the drawings. FIG. 11 is a perspective view of the magnetic core 1c according to a third modification of the present disclosure. FIG. 12 is a sectional view of the core back part 2 as seen from the first direction DIR1. Note that the following describes only differences of the magnetic core 1c according to the third modification from the magnetic core 1 according to the first embodiment and omits the rest.

As shown in FIGS. 11 and 12, the magnetic core 1c differs from the magnetic core 1 in that the first notch surface NS1 is L-shaped when seen from the first direction DIR1. The first notch surface NS1 is not limited to being a single flat surface, and only needs to include a flat surface, as shown in FIGS. 11 and 12.

The magnetic core 1c above offers the same advantageous effects as the magnetic core 1.

### Fourth Modification

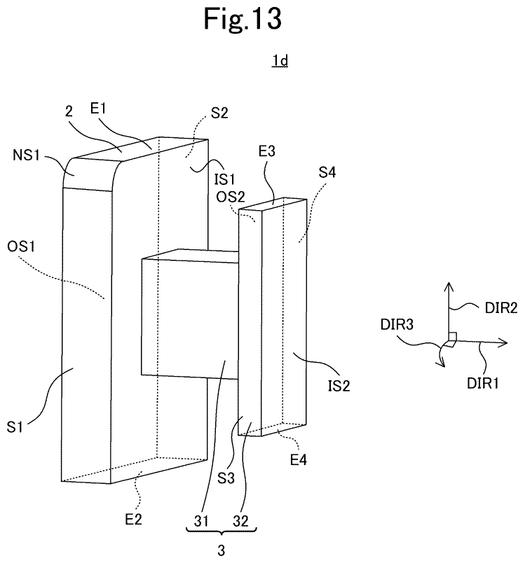

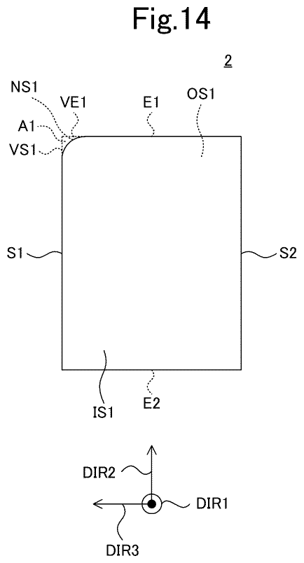

A magnetic core 1d according to a fourth modification of the present disclosure is described below with reference to the drawings. FIG. 13 is a perspective view of the magnetic core 1d according to the fourth modification of the present disclosure. FIG. 14 is a sectional view of the core back part 2 as seen from the first direction DIR1. Note that the following describes only differences of the magnetic core 1d according to the fourth modification from the magnetic core 1 according to the first embodiment and omits the rest.

As shown in FIGS. 13 and 14, the magnetic core 1d differs from the magnetic core 1 in that the first notch surface NS1 is a convex surface. In other words, the first notch surface NS1 is not limited to being a flat surface and may be a curved surface. In the present modification, the first notch surface NS1 is a convex surface curving in such a manner as to protrude from the center of the core back part 2 toward a portion of intersection between the first virtual extended end surface VE1 and the first virtual extended side surface VS1 when seen from the first direction DIR1.

The magnetic core 1d above can offer the same advantageous effects as the magnetic core 1. In addition, according to the magnetic core 1d, chipping of the core back part can be reduced more.

### Fifth Modification

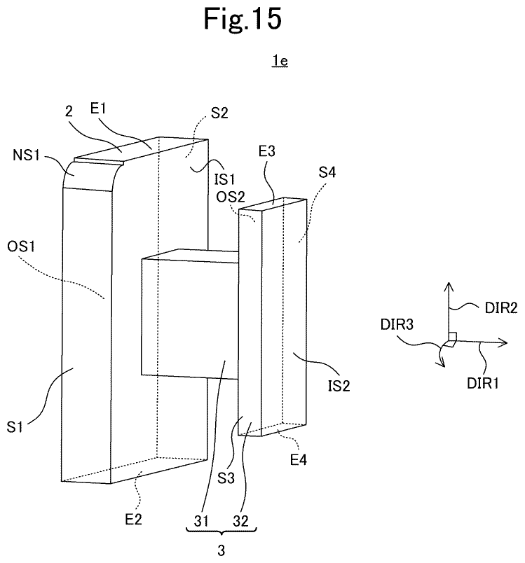

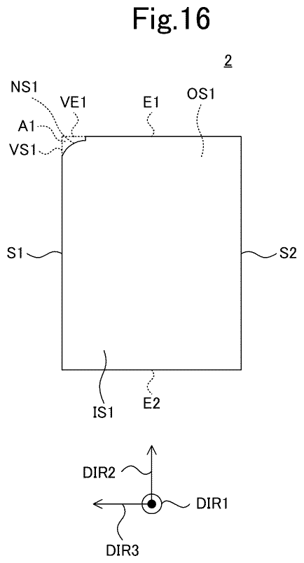

A magnetic core 1e according to a fifth modification of the present disclosure is described below with reference to the drawings. FIG. 15 is a perspective view of the magnetic core 1e according to the fifth modification of the present disclosure. FIG. 16 is a sectional view of the core back part 2 as seen from the first direction DIR1. Note that the following describes only differences of the magnetic core 1e according to the fifth modification from the magnetic core 1 according to the first embodiment and omits the rest.

As shown in FIGS. 15 and 16, the magnetic core 1e differs from the magnetic core 1 in the shape of the first notch surface NS1. The first notch surface NS1 is not limited to a single curved surface and only needs to include a curved surface. The first notch surface NS1 is not limited to a single convex surface and only needs to include a convex surface.

The magnetic core 1e above offers the same advantageous effects as the magnetic core 1.

### Second Embodiment

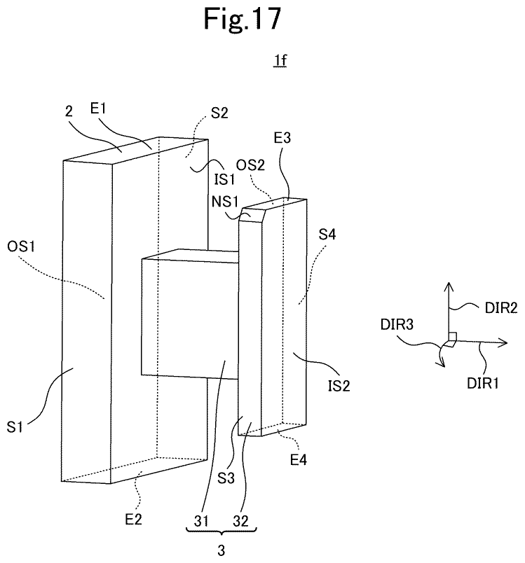

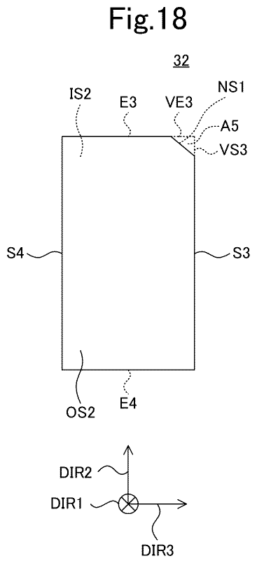

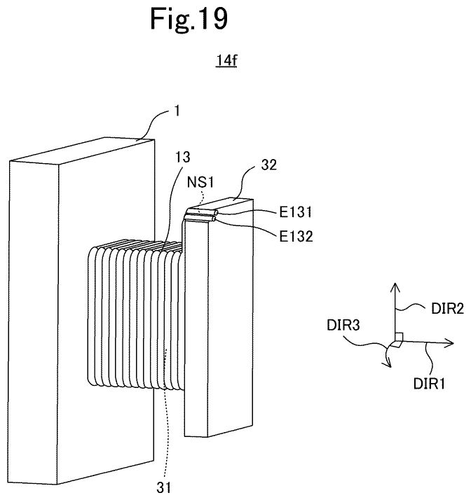

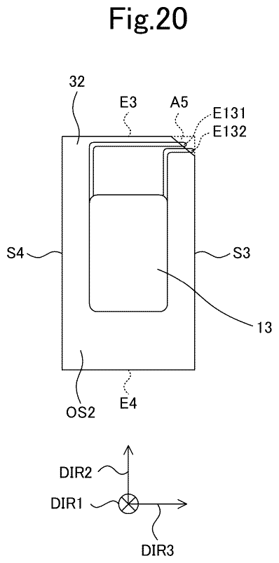

A magnetic core 1f and a coil-equipped magnetic core 14f according to a second embodiment of the present disclosure are described below with reference to the drawings. FIG. 17 is a perspective view of the magnetic core 1f according to the second embodiment of the present disclosure. FIG. 18 is a sectional view of the teeth tip end portion 32 as seen in the first direction DIR1. FIG. 19 is a perspective view of the coil-equipped magnetic core 14f. FIG. 20 is a sectional view of the teeth tip end portion 32 and the coil 13 as seen in the first direction DIR1. Note that the following describes only differences of the magnetic core 1f and the coil-equipped magnetic core 14f according to the second embodiment from the magnetic core 1 and the coil-equipped magnetic core 14 according to the first embodiment and omits the rest.

As shown in FIGS. 17 to 20, the magnetic core 1f differs from the magnetic core 1 in that the first notch surface NS1 is formed at the teeth tip end portion 32. In the present embodiment, the first notch surface NS1 is not formed at the core back part 2.

The teeth tip end portion 32 has a shape such that the end surface and the side surface are joined by a notch surface at least one of four combinations of surfaces one of which is selected from the two end surfaces, namely the third end surface E3 and the fourth end surface E4, and the other one of which is selected from the two side surfaces, namely the third side surface S3 and the fourth side surface S4. Specifically, conceivable four combinations are as follows: a combination of the third end surface E3 and the third side surface S3, a combination of the third end surface E3 and the fourth side surface S4, a combination of the fourth end surface E4 and the third side surface S3, and a combination of the fourth end surface E4 and the fourth side surface S4. In the present embodiment, as shown in FIGS. 17 and 18, the teeth tip end portion 32 has a shape such that the third end surface E3 and the third side surface S3 are joined with the first notch surface NS1 interposed therebetween. Also, in the present embodiment, the second inner main surface IS2 and the second outer main surface OS2 are joined by the first notch surface NS1.

In the present embodiment, as shown in FIG. 18 the first notch surface NS1 is, focusing on the combination of the third end surface E3 and the third side surface S3 joined by the first notch surface NS1, a surface formed to notch a portion of intersection between a third virtual extended end surface VE3 extended from the third end surface E3 in the third direction DIR3 and a third virtual extended side surface VS3 extended from the third side surface S3 in the second direction DIR2. Note that the third virtual extended end surface VE3 is a plane extended from the third end surface E3 in the circumferential direction about the rotary axis of the brushless motor 100 when the magnetic core 1f is mounted in the brushless motor 100. Also, the third virtual extended side surface VS3 is a plane extended from the third side surface S3 in the axial direction along the rotary axis of the brushless motor 100 when the magnetic core 1f is mounted in the brushless motor 100. In the present embodiment, as shown in FIGS. 17 and 18, the first notch surface NS1 is a flat surface. As shown in FIG. 18, a region surrounded by the third virtual extended end surface VE3, the third virtual extended side surface VS3, and the first notch surface NS1 is defined as a fifth region A5.

Each of the first end E131 and the second end E132 of the coil 13 is fixed to, for example, a terminal block (not shown) located farther in the first direction DIR1 than the teeth tip end portion 32. As shown in FIGS. 19 and 20, the coil 13 passes through the fifth region A5.

The magnetic core 1f above offers the same advantageous effects as the magnetic core 1. More specifically, the teeth tip end portion 32 has a shape such that the third end surface E3 and the third side surface S3 are joined with the first notch surface NS1 interposed therebetween. Thus, the teeth tip end portion 32 has a shape such that the third end surface E3 and the third side surface S3 are notched by the first notch surface NS1. This allows both end portions of the coil 13 wound on the teeth part 3 to be led out through the region created by the notching of the first notch surface NS1. As a result, according to the magnetic core 1f, a region is secured where both end portions of the coil can be led out.

Also, according to the magnetic core 1f, both end portions of the coil can be led out without a size increase of the rotary electric machine. More specifically, the first notch surface NS1 is, focusing on the combination of the third end surface E3 and the third side surface S3 joined by the first notch surface NS1, a surface formed to notch a portion of intersection between the third virtual extended end surface VE3 extended from the third end surface E3 in the third direction DIR3 and the third virtual extended side surface VS3 extended from the third side surface S3 in the second direction DIR2. This enables both end portions of the coil 13 to be led out through the fifth region A5, which is a region surrounded by the third virtual extended end surface VE3, the third virtual extended side surface VS3, and the first notch surface NS1. Thus, according to the magnetic core 1f, there is no need to secure a region for leading out both ends of the coil, outside of the magnetic core 1f. As a result, according to the magnetic core 1f, both end portions of the coil can be led out without a size increase of the rotary electric machine.

### Sixth Modification

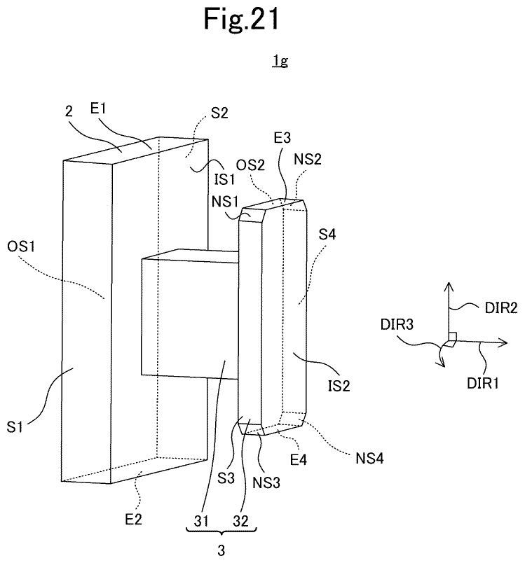

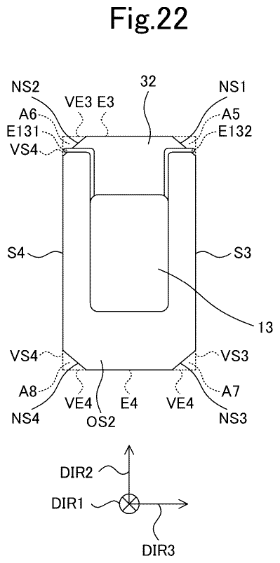

A magnetic core 1g and a coil-equipped magnetic core 14g according to a sixth modification of the present disclosure are described below with reference to the drawings. FIG. 21 is a perspective view of the magnetic core 1g according to the sixth modification of the present disclosure. FIG. 22 is a sectional view of the teeth tip end portion 32 and the coil 13 as seen in the first direction DIR1. Note that the following describes only differences of the magnetic core 1g and the coil-equipped magnetic core 14g according to the sixth modification from the magnetic core 1f and the coil-equipped magnetic core 14f according to the second embodiment and omits the rest.

As shown in FIGS. 21 and 22, the magnetic core 1g and the coil-equipped magnetic core 14g differ from the magnetic core 1f and the coil-equipped magnetic core 14f in that the shape of the teeth tip end portion 32 is such that the end surface and the side surface are joined by a notch surface at all of the four combinations of surfaces one of which is selected from the third end surface E3 and the fourth end surface E4 and the other one of which is selected from the third side surface S3 and the fourth side surface S4.

In the present modification, as shown in FIGS. 21 and 22, the third end surface E3 and the fourth side surface S4 are joined by the second notch surface NS2. Also, the fourth end surface E4 and the third side surface S3 are joined by the third notch surface NS3. Also, the fourth end surface E4 and the fourth side surface S4 are joined by the fourth notch surface NS4. Also, in the present modification, the second inner main surface IS2 and the second outer main surface OS2 are joined by each of the first notch surface NS1, the second notch surface NS2, the third notch surface NS3, and the fourth notch surface NS4.

In the present modification, as shown in FIG. 22, the second notch surface NS2 is, focusing on the combination of the third end surface E3 and the fourth side surface S4 joined by the second notch surface NS2, a surface formed to notch a portion of intersection between the third virtual extended end surface VE3 extended from the third end surface E3 in a direction opposite from the third direction DIR3 and a fourth virtual extended side surface VS4 extended from the fourth side surface S4 in the second direction DIR2. In the present modification, as shown in FIGS. 21 and 22, the second notch surface NS2 is a flat surface. As shown in FIG. 22, a region surrounded by the third virtual extended end surface VE3, the fourth virtual extended side surface VS4, and the second notch surface NS2 is defined as a sixth region A6.

In the present modification, as shown in FIG. 22, the third notch surface NS3 is, focusing on the combination of the fourth end surface E4 and the third side surface S3 joined by the third notch surface NS3, a surface formed to notch a portion of intersection between a fourth virtual extended end surface VE4 extended from the fourth end surface E4 in the third direction DIR3 and the third virtual extended side surface VS3 extended from the third side surface S3 in a direction opposite from the second direction DIR2. In the present modification, as shown in FIGS. 21 and 22, the third notch surface NS3 is a flat surface. As shown in FIG. 22, a region surrounded by the fourth virtual extended end surface VE4, the third virtual extended side surface VS3, and the third notch surface NS3 is defined as a seventh region A7.

In the present modification, as shown in FIG. 22, the fourth notch surface NS4 is, focusing on the combination of the fourth end surface E4 and the fourth side surface S4 joined by the fourth notch surface NS4, a surface formed to notch a portion of intersection between the fourth virtual extended end surface VE4 extended from the fourth end surface E4 in a direction opposite from the third direction DIR3 and the fourth virtual extended side surface VS4 extended from the fourth side surface S4 in a direction opposite from the second direction DIR2. In the present modification, as shown in FIGS. 21 and 22, the fourth notch surface NS4 is a flat surface. As shown in FIG. 22, a region surrounded by the fourth virtual extended end surface VE4, the fourth virtual extended side surface VS4, and the fourth notch surface NS4 is defined as an eighth region A8.

In the present modification, as shown in FIG. 22, the coil 13 passes through each of the fifth region A5 and the sixth region A6.

The magnetic core 1g above offers the same advantageous effects as the magnetic core 1f. In addition, according to the magnetic core 1g, chipping of the teeth tip end portion can be reduced. More specifically, the end surface and the side surface are joined by a notch surface at all of the four combinations of surfaces one of which is selected from the third end surface E3 and the fourth end surface E4 and the other one of which is selected from the third side surface S3 and the fourth side surface S4. Thus, according to the magnetic core 1g, chipping of the teeth tip end portion can be reduced.

Also, according to the magnetic core 1g, the degree of freedom for the coil wiring layout is improved. More specifically, the end surface and the side surface are joined by a notch surface at a plurality of ones of the four combinations of surfaces one of which is selected from the third end surface E3 and the fourth end surface E4 and the other one of which is selected from the third side surface S3 and the fourth side surface S4. Thus, both end portions of the coil 13 can be led out through at least one of the fifth region A5, the sixth region A6, the seventh region A7, and the eighth region A8. As a result, according to the magnetic core 1g, the degree of freedom for the coil wiring layout is improved.

### Seventh Modification

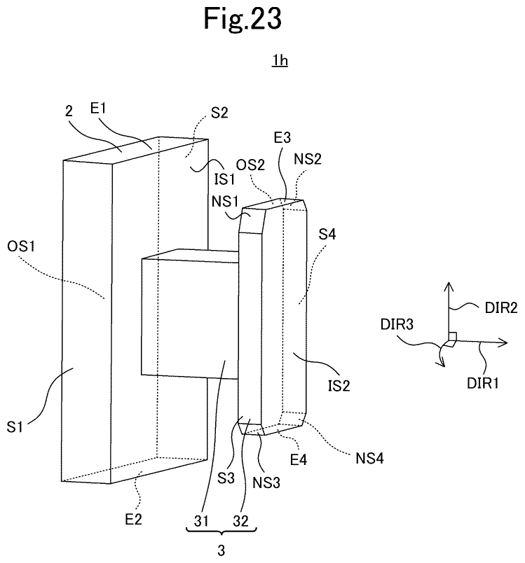

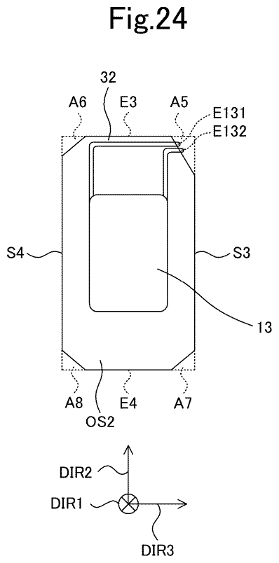

A magnetic core 1h and a coil-equipped magnetic core 14h according to a seventh modification of the present disclosure are described below with reference to the drawings. FIG. 23 is a perspective view of the magnetic core 1h according to the seventh modification of the present disclosure. FIG. 24 is a sectional view of the teeth tip end portion 32 and the coil 13 as seen in the first direction DIR1. Note that the following describes only differences of the magnetic core 1h and the coil-equipped magnetic core 14h according to the seventh modification from the magnetic core 1f and the coil-equipped magnetic core 14f according to the second embodiment and omits the rest.

As shown in FIGS. 23 and 24, the magnetic core 1h and the coil-equipped magnetic core 14h differ from the magnetic core 1f and the coil-equipped magnetic core 14f in that the area of the fifth region A5 is larger than each of the area of the sixth region A6, the area of the seventh region A7, and the area of the eighth region A8.

In the present modification, as shown in FIG. 24, the coil 13 passes through the fifth region A5. Meanwhile, the coil 13 passes through neither of the sixth region A6, the seventh region A7, and the eighth region A8. In other words, the coil 13 passes through the fifth region A5, which is a region with the largest area among the fifth region A5, the sixth region A6, the seventh region A7, and the eighth region A8.

The magnetic core 1h above offers the same advantageous effects as the magnetic core 1f. Also, according to the magnetic core 1h, chipping of the teeth tip end portion can be reduced with a region secured for allowing both end portions of the coil to be led out. More specifically, the area of the fifth region A5 is larger than each of the area of the sixth region A6, the area of the seventh region A7, and the area of the eighth region A8. Thus, the coil 13 can pass through the fifth region A5, which is a region with the largest area. Also, the end surface and the side surface are joined by a notch surface at a plurality of ones of the four combinations of surfaces one of which is selected from the third end surface E3 and the fourth end surface E4 and the other one of which is selected from the third side surface S3 and the fourth side surface S4. Thus, chipping of the teeth tip end portion 32 can be reduced. As a result, according to the magnetic core 1h, chipping of the teeth tip end portion can be reduced with a region secured for allowing both end portions of the coil to be led out.

### Eighth Modification

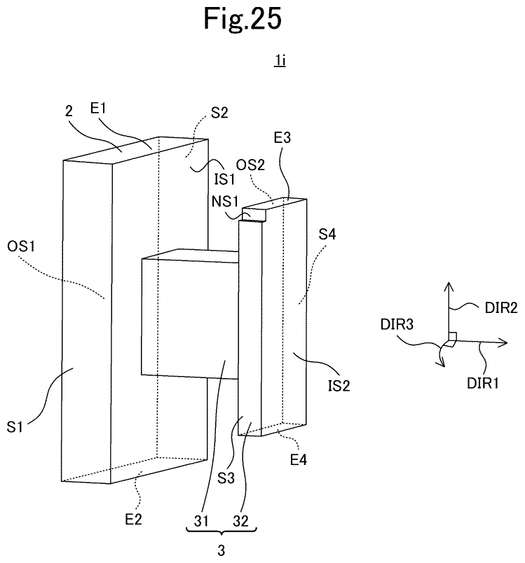

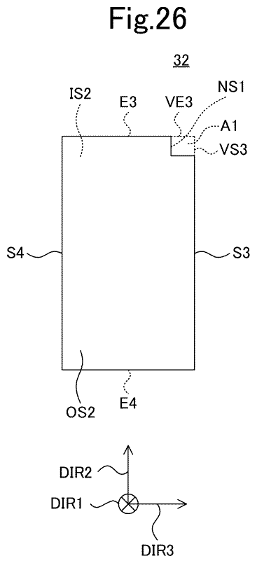

A magnetic core 1i according to an eighth modification of the present disclosure is described below with reference to the drawings. FIG. 25 is a perspective view of the magnetic core 1i according to the eighth modification of the present disclosure. FIG. 26 is a sectional view of the teeth tip end portion 32 as seen in the first direction DIR1. Note that the following describes only differences of the magnetic core 1i according to the eighth modification from the magnetic core 1f according to the second embodiment and omits the rest.

As shown in FIGS. 25 and 26, the magnetic core 1i differs from the magnetic core lf in that the first notch surface NS1 is L-shaped when seen in the first direction DIR1. The first notch surface NS1 is not limited to being a single flat surface and only needs to include a flat surface, as shown in FIGS. 25 and 26.

The magnetic core 1i above offers the same advantageous effects as the magnetic core 1f.

### Ninth Modification

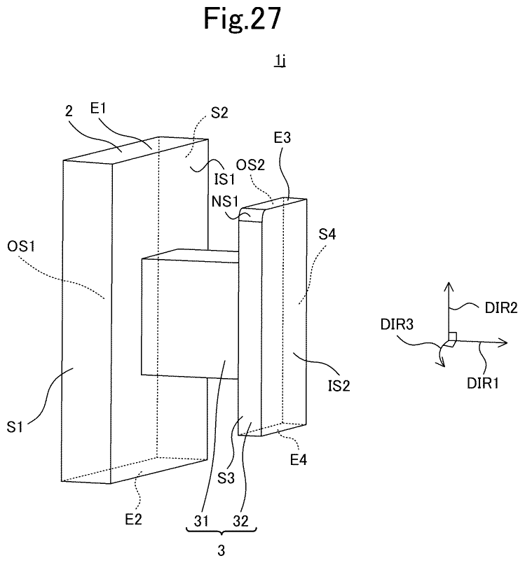

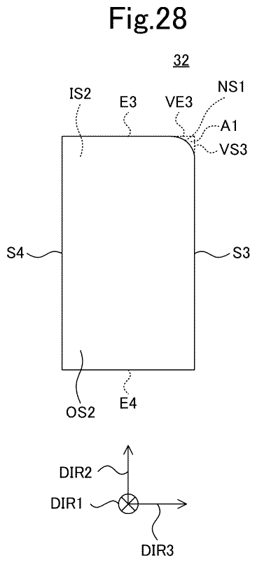

A magnetic core 1j according to a ninth modification of the present disclosure is described below with reference to the drawings. FIG. 27 is a perspective view of the magnetic core 1j according to the ninth modification of the present disclosure. FIG. 28 is a sectional view of the teeth tip end portion 32 as seen in the first direction DIR1. Note that the following describes only differences of the magnetic core 1j according to the ninth modification from the magnetic core 1f according to the second embodiment and omits the rest.

As shown in FIGS. 27 and 28, the magnetic core 1j differs from the magnetic core 1f in that the first notch surface NS1 is a convex surface. In other words, the first notch surface NS1 is not limited to being a flat surface and may be a curved surface. In the present modification, the first notch surface NS1 is a convex surface curving in such a manner as to protrude from the center of the teeth tip end portion 32 toward a portion of intersection between the third virtual extended end surface VE3 and the third virtual extended side surface VS3 as seen in the first direction DIR1.

The magnetic core 1j above offers the same advantageous effects as the magnetic core 1f. Also, according to the magnetic core 1j, chipping of the teeth tip end portion can be reduced more.

### Tenth Modification

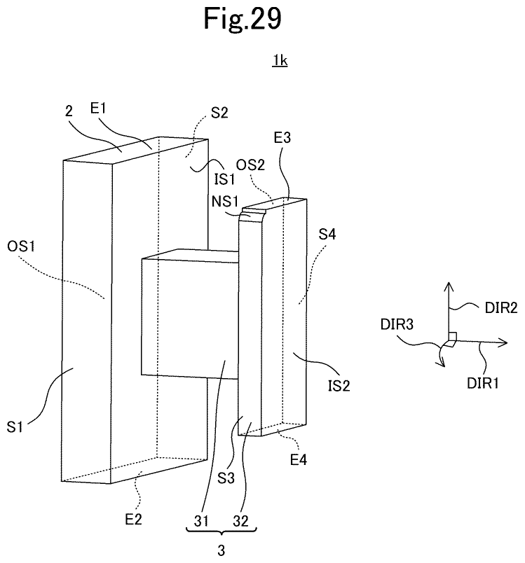

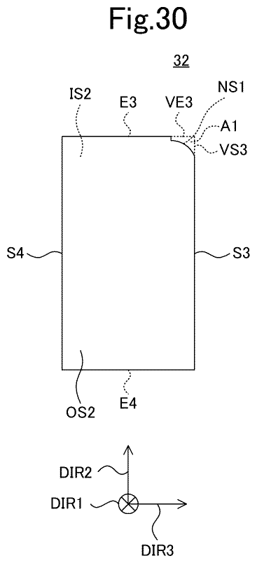

A magnetic core 1k according to a tenth modification of the present disclosure is described below with reference to the drawings. FIG. 29 is a perspective view of the magnetic core 1k according to the tenth modification of the present disclosure. FIG. 30 is a sectional view of the teeth tip end portion 32 as seen in the first direction DIR1. Note that the following describes only differences of the magnetic core 1k according to the tenth modification from the magnetic core 1f according to the second embodiment and omits the rest.

As shown in FIGS. 29 and 30, the magnetic core 1k differs from the magnetic core 1f in the shape of the first notch surface NS1. The first notch surface NS1 is not limited to being a single curved surface and only needs to include a curved surface. Also, the first notch surface NS1 is not limited to being a single convex surface and only needs to include a convex surface.

The magnetic core 1k above offers the same advantageous effects as the magnetic core 1f .

### Other Embodiments

The magnetic core according to the present disclosure is not limited to the magnetic cores 1, 1a to 1k and can be modified within the scope of the gist thereof. Also, the structures of the magnetic cores 1, 1a to 1k may be combined in any way.

The coil-equipped magnetic core according to the present disclosure is not limited to the coil-equipped magnetic core 14, 14a to 14k having a corresponding one of the magnetic cores 1, 1a to 1k and the coil 13 and may be modified within the scope of the gist thereof. Also, the structures of the coil-equipped magnetic cores 14, 14a to 14k may be combined in any way.

Note that the rotary electric machine has a structure where a rotor rotates using electricity or a structure where electricity is generated by rotation of a rotor. Examples of a rotary electric machine include a brushless motor, a permanent magnet synchronous motor, and a permanent magnet synchronous generator. In this case, a rotary electric machine only needs to have at least one of the magnetic cores 1, 1a to 1k and may have a brush.

Note that when the magnetic core 1 is mounted in the brushless motor 100, the first direction DIR1 does not have to be directed in a direction opposite from the radial direction about the rotary axis of the brushless motor 100.

Note that each of the first end surface E1, the second end surface E2, the third end surface E3, and the fourth end surface E4 does not have to be a flat surface. Also, each of the first side surface S1, the second side surface S2, the third side surface S3, and the fourth side surface S4 does not have to be a flat surface. Also, each of the first inner main surface IS1, the first outer main surface OS1, the second inner main surface IS2, and the second outer main surface OS2 does not have to be a flat surface.

Note that the first inner main surface IS1 and the first outer main surface OS1 do not have to be joined by the first notch surface NS1. Also, the first inner main surface IS1 and the first outer main surface OS1 do not have to be joined by the second notch surface NS2. Also, the first inner main surface IS1 and the first outer main surface OS1 do not have to be joined by the third notch surface NS3. Also, the first inner main surface IS1 and the first outer main surface OS1 do not have to be joined by the fourth notch surface NS4.

Note that the brushless motor 100 may be an outer-rotor type.

Note that the brushless motor 100 is not limited to a single-shaft type. The brushless motor 100 may be, for example, a double-shaft type.

Note that the first bearing 11a and the second bearing 11b are each not limited to a ball bearing.

Note that materials for the first casing 12a and the second casing 12b may be any materials as long as they offer high rigidity.

Note that the number of the coil-equipped magnetic core 14 is not limited to nine.

Note that in each of the magnetic core 1 and the coil-equipped magnetic core 14, in place of the first notch surface NS1, at least one of the first notch surface NS1, the second notch surface NS2, the third notch surface NS3, and the fourth notch surface NS4 may be formed at the core back part 2.

Note that in the coil-equipped magnetic core 14a, the coil 13 does not necessarily have to pass through each of the first region A1 and the second region A2. In the coil-equipped magnetic core 14a, the coil 13 only has to pass through at least one of the first region A1, the second region A2, the third region A3, and the fourth region A4.

Note that in each of the magnetic core 1b and the coil-equipped magnetic core 14b, the area of the first region A1 does not have to be larger than each of the area of the second region A2, the area of the third region A3, and the area of the fourth region A4. More specifically, the end surface and the side surface do not need to be joined by a notch surface at all of the four combinations (the combination of the first end surface E1 and the first side surface S1, the combination of the first end surface E1 and the second side surface S2, the combination of the second end surface E2 and the first side surface S1, and the combination of the second end surface E2 and the second side surface S2) as long as the end surface and the side surface are joined by a notch surface at a plurality of ones of the four combinations. Also, the area of the first region A1 does not necessarily need to be larger than each of the area of the second region A2, the area of the third region A3, and the area of the fourth region A4. For example, the area of the second region A2 may be larger than each of the area of the first region A1, the area of the third region A3, and the area of the fourth region A4. In this case, the coil 13 passes through the second region A2, which is a region with the largest area.

Note that in the magnetic core 1c, the first notch surface NS1 does not have to be L-shaped when seen from the first direction DIR1.

Note that in the magnetic core 1d, the first notch surface NS1 does not have to be a convex surface curving in such a manner as to protrude from the center of the core back part 2 toward a portion of intersection between the first virtual extended end surface VE1 and the first virtual extended side surface VS1 as seen from the first direction DIR1.

Note that the second inner main surface IS2 and the second outer main surface OS2 do not have to be joined by the first notch surface NS1. Also, the second inner main surface IS2 and the second outer main surface OS2 do not have to be joined by the second notch surface NS2. Also, the second inner main surface IS2 and the second outer main surface OS2 do not have to be joined by the third notch surface NS3. Also, the second inner main surface IS2 and the second outer main surface OS2 do not have to be joined by the fourth notch surface NS4.

Note that in each of the magnetic core 1f and the coil-equipped magnetic core 14f, in place of the first notch surface NS1, at least one of the first notch surface NS1, the second notch surface NS2, the third notch surface NS3, and the fourth notch surface NS4 may be formed at the teeth tip end portion 32.

Note that in the coil-equipped magnetic core 14g, the coil 13 does not necessarily need to pass through each of the fifth region A5 and the sixth region A6. In the coil-equipped magnetic core 14g, the coil 13 only has to pass at least one of the fifth region A5, the sixth region A6, the seventh region A7, and the eighth region A8.

Note that in each of the magnetic core 1h and the coil-equipped magnetic core 14h, the area of the fifth region A5 does not have to be larger than each of the area of the sixth region A6, the area of the seventh region A7, and the area of the eighth region A8. More specifically, the end surface and the side surface do not need to be joined by a notch surface at all of the four combinations (the combination of the third end surface E3 and the third side surface S3, the combination of the third end surface E3 and the fourth side surface S4, the combination of the fourth end surface E4 and the third side surface S3, and the combination of the fourth end surface E4 and the fourth side surface S4) as long as the end surface and the side surface are joined by a notch surface at a plurality of ones of the four combinations. Also, the area of the fifth region A5 does not necessarily have to be larger than each of the area of the sixth region A6, the area of the seventh region A7, and the area of the eighth region A8, and for example, the area of the sixth region A6 may be larger than each of the area of the fifth region A5, the area of the seventh region A7, and the area of the eighth region A8. In this case, the coil 13 passes through the sixth region A6, which is a region with the largest area.

Note that in the magnetic core 1i, the first notch surface NS1 does not need to be L-shaped when seen in the first direction DIR1.

Note that in the magnetic core 1j, the first notch surface NS1 does not have to be a convex surface curving in such a manner as to protrude from the center of the teeth tip end portion 32 toward a portion of intersection between the third virtual extended end surface VE3 and the third virtual extended side surface VS3 when seen in the first direction DIR1.

Note that each of the first notch surface NS1, the second notch surface NS2, the third notch surface NS3, and the fourth notch surface NS4 may be formed at both of the core back part 2 and the teeth tip end portion 32.

Note that the magnetic cores 1, 1a to 1k may be fabricated by lamination of electromagnetic steel sheets.

The present disclosure has the following configurations.
(1) A magnetic core for a rotary electric machine, the magnetic core including: a core back part; and a teeth part, wherein the core back part has: a first end surface directed in an axial direction and extending along a rotary axis of the rotary electric machine, and a second end surface directed in a direction opposite from the axial direction when the magnetic core is mounted in the rotary electric machine, and a first side surface and a second side surface positioned side by side in a circumferential direction about the rotary axis when the magnetic core is mounted in the rotary electric machine, and the core back part has a shape where a notch surface is interposed in between at least one of: (1) the first end surface and the first side surface, (2) the first end surface and the second side surface, (3) the second end surface and the first side surface, and (4) the second end surface and the second side surface.
(2) The magnetic core according to (1), in which the notch surface is a surface that intersects a virtual extended end surface extended in the circumferential direction and a virtual extended side surface extended in the axial direction of the at least one of (1), (2), (3), and (4).
(3) The magnetic core according to (2), in which the notch surface is present at all of (1), (2), (3), and (4).
(4) The magnetic core according to (2) or (3), in which the notch surface is present at a plurality of (1), (2), (3), and (4), and an area of a region surrounded by the virtual extended end surface, the virtual extended side surface, and the notch surface is larger at a first of the at least one of (1), (2), (3), and (4) than at a rest of the plurality of the at least one of (1), (2), (3), and (4).
(5) The magnetic core according to any one of (1) to (4), in which the notch surface includes a flat surface.
(6) The magnetic core according to any one of (1) to (5), in which the notch surface includes a convex surface.
(7) A coil-equipped magnetic core including: the magnetic core according to (2) or (3) and a coil wound on the teeth part such that the coil passes through a region surrounded by the virtual extended end surface, the virtual extended side surface, and the notch surface.
(8) A coil-equipped magnetic core including: the magnetic core according to (4) and a coil wound on the teeth part such that the coil passes through the region with the largest area.
(9) A magnetic core for a rotary electric machine, the magnetic core including: a core back part; and a teeth part, wherein the teeth part includes: a teeth main body portion extending from the core back part toward a rotor of the rotary electric machine when the magnetic core is mounted in the rotary electric machine and a teeth tip end portion at a tip end of the teeth main body portion, wherein the teeth tip end portion has: a first end surface directed in an axial direction and extending along a rotary axis of the rotary electric machine, and a second end surface directed in a direction opposite from the axial direction when the magnetic core is mounted in the rotary electric machine, and a first side surface and a second side surface positioned side by side in a circumferential direction about the rotary axis when the magnetic core is mounted in the rotary electric machine, and the teeth tip end portion has a shape where a notch surface interposed in between at least one of: (1) the first end surface and the first side surface, (2) the first end surface and the second side surface, (3) the second end surface and the first side surface, and (4) the second end surface and the second side surface.
(10) The magnetic core according to (9), in which the notch surface is a surface that intersects a virtual extended end surface extended in the circumferential direction and a virtual extended side surface extended in the axial direction of the at least one of (1), (2), (3), and (4).
(11) The magnetic core according to (10), in which the notch surface is present at all of (1), (2), (3), and (4).
(12) The magnetic core according to (10) or (11), in which the notch surface is present at a plurality of (1), (2), (3), and (4), and an area of a region surrounded by the virtual extended end surface, the virtual extended side surface, and the notch surface is larger at a first of the at least one of (1), (2), (3), and (4) than at a rest of the plurality of the at least one of (1), (2), (3), and (4).
(13) The magnetic core according to any one of (9) to (12), in which the notch surface includes a flat surface.
(14) The magnetic core according to any one of (9) to (13), in which the notch surface includes a convex surface.
(15) A coil-equipped magnetic core including: the magnetic core according to (10) or (11) and a coil wound on the teeth main body portion such that the coil passes through a region surrounded by the virtual extended end surface, the virtual extended side surface, and the notch surface.
(16) A coil-equipped magnetic core including: the magnetic core according to (12) and a coil wound on the teeth main body portion such that the coil passes through the region with the largest area.
(17) The magnetic core according to any one of (1) to 6) or any one of (9) to (14), in which the magnetic core is a compact comprising soft magnetic powder.
(18) A rotary electric machine including the magnetic core according to any one of (1) to (6), any one of (9) to (14), or (17).

### REFERENCE SIGNS LIST

1, 1a, 1b, 1c, 1d, 1e, 1f, 1g, 1h, 1i, 1j, 1k magnetic core
2 core back part
3 teeth part
10 stator assembly
11 bearing
11a first bearing
11b second bearing
12 casing
12a first casing
12b second casing
13 coil
14, 14a, 14b, 14c, 14d, 14e, 14f, 14g, 14h, 14i, 14j, 14k coil-equipped magnetic core
20 rotor
21 shaft
22 rotor member
23 soft magnetic body
24 hard magnetic body
31 teeth main body portion
32 teeth tip end portion
100 brushless motor
A1 first region
A2 second region
A3 third region
A4 fourth region
A5 fifth region
A6 sixth region
A7 seventh region
A8 eighth region
DIR1 first direction
DIR2 second direction
DIR3 third direction
E131 first end
E132 second end
E1 first end surface
E2 second end surface
E3 third end surface
E4 fourth end surface
IS1 first inner main surface
IS2 second inner main surface
NS1 first notch surface
NS2 second notch surface
NS3 third notch surface
NS4 fourth notch surface
OP opening
OS1 first outer main surface
OS2 second outer main surface
S1 first side surface
S2 second side surface
S3 third side surface
S4 fourth side surface
VE1 first virtual extended end surface
VE2 second virtual extended end surface
VE3 third virtual extended end surface
VE4 fourth virtual extended end surface
VS1 first virtual extended side surface
VS2 second virtual extended side surface
VS3 third virtual extended side surface
VS4 fourth virtual extended side surface

1. A magnetic core for a rotary electric machine, the magnetic core comprising:
a core back part; and
a teeth part, wherein
the core back part has:
a first end surface directed in an axial direction and extending along a rotary axis of the rotary electric machine, and a second end surface directed in a direction opposite from the axial direction when the magnetic core is mounted in the rotary electric machine, and
a first side surface and a second side surface positioned side by side in a circumferential direction about the rotary axis when the magnetic core is mounted in the rotary electric machine, and
the core back part has a shape where a notch surface is interposed in between at least one of:
(1) the first end surface and the first side surface,
(2) the first end surface and the second side surface,
(3) the second end surface and the first side surface, and
(4) the second end surface and the second side surface.

2. The magnetic core according to claim 1, wherein
the core back part includes an inner main surface joining respective end edges of the first end surface and the second end surface in terms of the first direction to each other, and an outer main surface joining respective end edges of the first end surface and the second end surface in terms of a direction opposite from the first direction to each other, and
the core back part has a shape such that the inner main surface and the outer main surface are joined with the notch surface interposed in between.

3. The magnetic core according to claim 1, wherein the notch surface is a surface that intersects a virtual extended end surface extended in the circumferential direction and a virtual extended side surface extended in the axial direction of the at least one of (1), (2), (3), and (4).

4. The magnetic core according to claim 3, wherein the notch surface is present at all of (1), (2), (3), and (4).

5. The magnetic core according to claim 3, wherein
the notch surface is present at a plurality of (1), (2), (3), and (4), and
an area of a region surrounded by the virtual extended end surface, the virtual extended side surface, and the notch surface is larger at a first of the at least one of (1), (2), (3), and (4) than at a rest of the plurality of the at least one of (1), (2), (3), and (4).

6. The magnetic core according to claim 1, wherein the notch surface includes a flat surface.

7. The magnetic core according to claim 1, wherein the notch surface includes a convex surface.

8. A coil-equipped magnetic core comprising:
the magnetic core according to claim 3; and
a coil wound on the teeth part such that the coil passes through a region surrounded by the virtual extended end surface, the virtual extended side surface, and the notch surface.

9. A coil-equipped magnetic core comprising:
the magnetic core according to claim 5; and
a coil wound on the teeth part such that the coil passes through the first of the at least one of (1), (2), (3), and (4).

10. A magnetic core for a rotary electric machine, the magnetic core comprising:
a core back part; and
a teeth part, wherein
the teeth part includes:
a teeth main body portion extending from the core back part toward a rotor of the rotary electric machine when the magnetic core is mounted in the rotary electric machine and
a teeth tip end portion at a tip end of the teeth main body portion, wherein the teeth tip end portion has:
a first end surface directed in an axial direction and extending along a rotary axis of the rotary electric machine, and a second end surface directed in a direction opposite from the axial direction when the magnetic core is mounted in the rotary electric machine, and
a first side surface and a second side surface positioned side by side in a circumferential direction about the rotary axis when the magnetic core is mounted in the rotary electric machine, and
the teeth tip end portion has a shape where a notch surface interposed in between at least one of:
(1) the first end surface and the first side surface,
(2) the first end surface and the second side surface,
(3) the second end surface and the first side surface, and
(4) the second end surface and the second side surface.

11. The magnetic core according to claim 10, wherein the notch surface is a surface that intersects a virtual extended end surface extended in the circumferential direction and a virtual extended side surface extended in the axial direction of the at least one of (1), (2), (3), and (4).

12. The magnetic core according to claim 11, wherein the notch surface is present at all of (1), (2), (3), and (4).

13. The magnetic core according to claim 11, wherein
the notch surface is present at a plurality of (1), (2), (3), and (4), and
an area of a region surrounded by the virtual extended end surface, the virtual extended side surface, and the notch surface is larger at a first of the at least one of (1), (2), (3), and (4) than at a rest of the plurality of the at least one of (1), (2), (3), and (4).

14. The magnetic core according to claim 10, wherein the notch surface includes a flat surface.

15. The magnetic core according to claim 10, wherein the notch surface includes a convex surface.

16. A coil-equipped magnetic core comprising:
the magnetic core according to claim 11; and
a coil wound on the teeth main body portion such that the coil passes through a region surrounded by the virtual extended end surface, the virtual extended side surface, and the notch surface.

17. A coil-equipped magnetic core comprising:
the magnetic core according to claim 13; and
a coil wound on the teeth main body portion such that the coil passes through the first of the at least one of (1), (2), (3), and (4).

18. The magnetic core according to claim 1, wherein the magnetic core is a compact comprising soft magnetic powder.

19. A rotary electric machine comprising the magnetic core according to claim 1.

20. A rotary electric machine comprising the magnetic core according to claim 10.
